(19) United States
(12) Patent Application Publication
(10) Pub. No.: US 2016/0376849 A1
(43) Pub. Date: Dec. 29, 2016

(54) ELECTRICAL CONNECTIVITY ACROSS A TOOL JOINT

(71) Applicant: Schlumberger Technology Corporation, Sugar Land, TX (US)

(72) Inventor: Caleb M. Zimmerman, Spring, TX (US)

(21) Appl. No.: 15/191,904

(22) Filed: Jun. 24, 2016

Related U.S. Application Data
(60) Provisional application No. 62/185,559, filed on Jun. 26, 2015.

(51) Int. Cl. E21B 17/02; F16L 15/08; F16L 25/02; E21B 17/042

(52) U.S. Cl. CPC E21B 17/028; E21B 17/042; F16L 15/08; F16L 25/021; E21B 47/00

(57) ABSTRACT

A tubular member includes a pin joint and a box joint. A conductor extends along a body of the tubular member, between the pin joint and the box joint. The conductor may extend to an end face of the pin joint and to at least an internal shoulder of the box joint. When coupled with another tubular member, a conductor on a pin joint can shoulder out with a conductor on a box joint to allow an electrical connection between the tubular components.

### CROSS-REFERENCE TO RELATED APPLICATIONS

This application claims the benefit of, and priority to, U.S. Patent Application Ser. No. 62/185,559, filed Jun. 26, 2015, which application is expressly incorporated herein by this reference in its entirety.

### BACKGROUND

In drilling a wellbore in a subterranean formation, such as for the recovery of hydrocarbons or for other applications, a drill bit is connected to the lower end of a drill string. The drill string may include multiple drill pipe sections connected end-to-end, and the drill string may be rotated by a rotary table or top drive at the surface. The rotation from the surface is conveyed through the drill string to the drill bit by the drill pipe sections. As weight-on-bit is applied to the rotating drill bit, the wellbore may be formed by using the drill bit to cut through the formation material by abrasion, fracturing, or shearing action.

Other drilling systems may include a downhole motor used to rotate the drill bit. A drill string may include coiled tubing, sections of drill pipe, or some other tubular element that is coupled to the downhole motor. Fluid is conveyed through the surface through the drill string, and the downhole motor converts the hydraulic energy of the fluid to rotational energy that can rotate the drill bit. Downhole motors may include positive displacement motors that use lobed rotors that rotate as fluid flows through the downhole motors. Other downhole motors may include turbines which use rotors with various blades. As fluid flows against the rotor blades, the rotor may rotate. For a positive displacement motor or a turbine, a shaft may be coupled to the rotor and the drill bit. As the rotor rotates, the shaft and drill bit may also rotate to cut through the formation material.

Other downhole operations, including milling, may also be performed using similar processes. In the case of milling, a drill string may rotate through surface-applied rotation or through use of downhole motor. A window mill, lead mill, section mill, junk mill, or other type of mill may then be rotated to perform a downhole milling operation. Regardless of whether drilling, milling, or other downhole operations are performed, a downhole tool may be operated by using sensors or measurements that are obtained downhole, at the surface, or both. Downhole sensors may, for instance, measure the downhole motion and trajectory of a drill bit in a drilling operation, or the motion and trajectory of a lead mill in a sidetracking operation. Information about these measurements may be conveyed to the surface using mud pulse telemetry to allow an operator at the surface to understand what is happening downhole. Similarly, instructions for the downhole tool—such as steering instructions for a drill bit or mill—may be sent from the surface using similar telemetry operations. A downhole receiver may receive the instructions and use them to operate the downhole tool.

### SUMMARY

Some embodiments described herein relate to systems, devices, and methods that enable communication and/or transmission of power. Some embodiments described herein enable electrical connectivity across threaded connections. A tubular member used in a threaded connection may include a box joint, a pin joint, and a body between the box and pin joints. A conductor may extend along a full length of the body and along at least a portion of each of the box joint to the pin joint. The conductor may include a strip of conductive material deposited on an interior surface of the body, box joint, and pin joint.

In other embodiments, a method for providing electrical conductivity across a tool joint includes threadably coupling a pin joint of a first tubular member to a box joint of a second tubular member. The first tubular member includes a first conductive material on an end face of the pin joint. The second tubular member including a second conductive material on an internal shoulder of the box joint. The pin joint and box joint can be shouldered out, thereby causing the first and second conductors to contact.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

So that the recited features can be understood in detail, a more particular description may be had by reference to one or more embodiments, some of which are illustrated in the appended drawings. It is to be noted, however, that the appended drawings are illustrative embodiments, and are, therefore, not to be considered limiting of the scope of the present disclosure or the claims.

FIG. 1 is a partial section view of a threaded connection, according to one or more embodiments of the present disclosure.

FIG. 2 is a partial section view of portions of the threaded connection of FIG. 1, according to one or more embodiments of the present disclosure.

FIG. 3 is a partial section view of an illustrative connection assembly that may be removable from the apparatus depicted in FIG. 1, according to one or more embodiments of the present disclosure.

FIG. 4 is a partial section view of an illustrative threaded connection having a removable connector, according to one or more embodiments of the present disclosure.

FIG. 5 is a schematic illustration of a drilling system, according to one or more embodiments of the present disclosure.

FIG. 6 is a flow chart illustrating a method for providing electrical connectivity across a threaded connection, according to one or more embodiments of the present disclosure.

FIG. 7-1 is a cross-sectional view of a tubular member having a conductor extending along a body of the tubular member, and to box and pin joints on opposing ends of the body, according to one or more embodiments of the present disclosure.

FIG. 7-2 is a side view of the tubular member of FIG. 7-1.

FIGS. 7-3 and 7-4 are left and right end views, respectively, of the tubular member of FIGS. 7-1 and 7-2.

FIG. 8-1 is a cross-sectional view of a tubular member having a conductor extending along a body of the tubular member, and to box and pin joints on opposing ends of the body, according to one or more embodiments of the present disclosure.

FIG. 8-2 is a side view of the tubular member of FIG. 8-1.

FIGS. 8-3 and 8-4 are left and right end views, respectively, of the tubular member of FIGS. 8-1 and 8-2.

FIGS. 9-13 are schematic cross sections of various conductors, according to one or more embodiments of the present disclosure.

### DETAILED DESCRIPTION

In at least some embodiments, communication and transmission of data or power may occur between a downhole tool positioned in a wellbore and a remotely located operator or control system. According to the same or other embodiments, communication or transmission of data or power may be facilitated by enabling electrical connectivity across one or more mechanical connections. For example, in one embodiment, a threaded connection, such as a rotary shouldered connection, may be formed when an externally threaded tubular member and an internally threaded tubular member are joined together. Electrical conductivity, which enables bidirectional data and/or power transmission, may be established across the threaded connection by utilizing a compression device to compress a conductor, such as a conductive wire, in one of the tubular members toward a conductor, such as a conductive wire, patterned onto the other tubular member, for example, via a direct write process and/or an additive manufacturing process. In some embodiments, this electrical connection between the conductors may be made after the tubular members are coupled together to form the threaded connection and are made-up by applying the desired torque. Further, in certain embodiments, electrical conductivity may be established and a wiring cavity may be sealed by, for example, the utilization of the compression device. In some embodiments, the electrical connection may increase reliability of communication over the connection and reduce manufacturing and/or assembly complexity. These and other features of the presently disclosed embodiments are discussed in more detail herein.

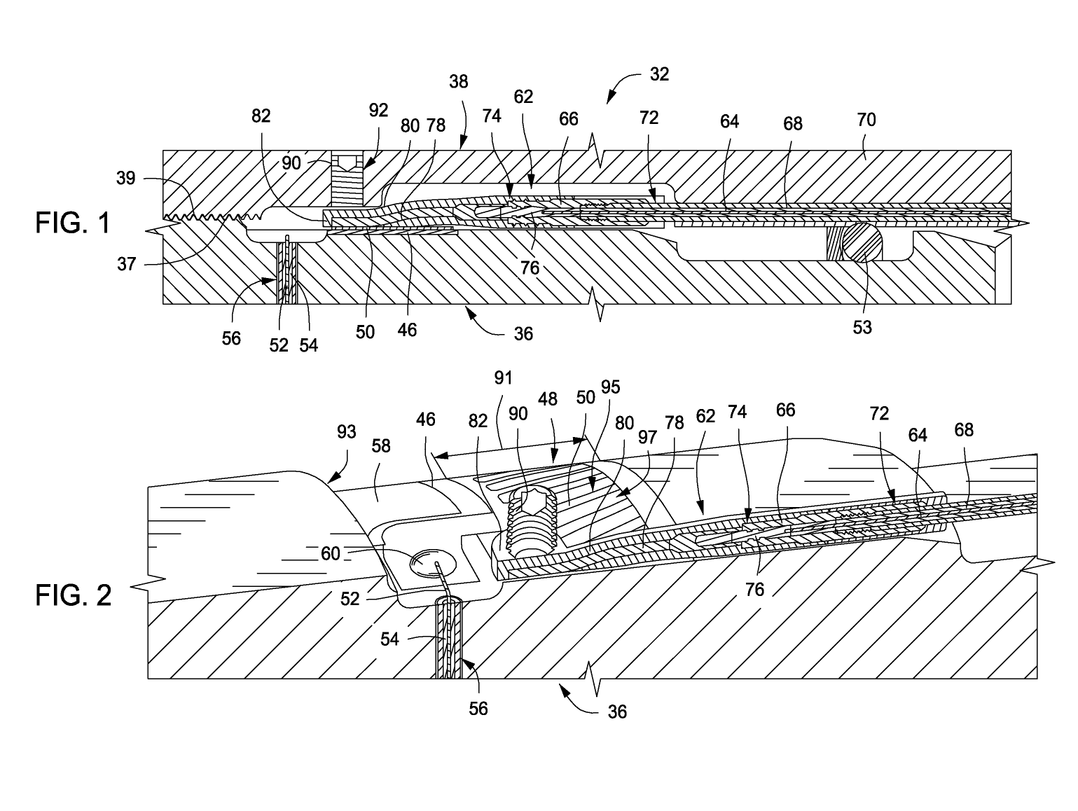

FIG. 1 is a partial section view of an illustrative apparatus 32 for providing electrical connectivity across a threaded connection, according to one or more embodiments. In some embodiments, the threaded connection may be an API connection, a rotary shouldered connection, or any other type of connection having internal and external threads. The apparatus 32 may include a first tubular member 36 with threads 37 that engage threads 39 of a second tubular member 38, forming the threaded connection therebetween. The threads 37 of the first tubular member 36 may include external or pin threads, and the threads 39 of the second tubular member 38 may include internal or box threads that are configured to mate with the external threads of the first tubular member 36 to form the threaded connection of the apparatus 32. As such, in some embodiments, the first tubular member 36 may form a pin end of the threaded connection, and the second tubular member 38 may form a box end of the threaded connection.

A first non-conductive coating 46 may be applied to an outer surface of the first tubular member 36, and a first conductor 50 (e.g., a conductive wire, plating, or film) may be formed or applied via a suitable manufacturing process onto the first non-conductive coating 46. The first non-conductive coating 46 may enable the first conductor 50 to be partially or completely electrically isolated from the surface on which the first non-conductive coating 46 is patterned. To that end, the first non-conductive coating 46 may be a partial or complete electrical insulator configured to reduce or prevent the conduction of electricity between the first conductor 50 and the surface on which the first non-conductive coating 46 is patterned. In some embodiments, the non-conductive coating 46 may be formed from a ceramic, a dielectric, a non-conductive epoxy, any suitable type of insulative material, or a combination thereof.

Additionally, the second tubular member 38 may include a body 70 defining a passageway 92 terminating proximate a non-conductive pad 82 coupled to a conductor 78 in the body 70. The non-conductive pad 82 may be configured to partially or completely electrically isolate the conductor 78 from a compression device 90 and/or any other electrically conductive device coming into contact with the non-conductive pad 82. To that end, the first non-conductive pad 82 may be a partial or complete electrical insulator configured to reduce or prevent the conduction of electricity between the conductor 78 and the compression device 90. In some embodiments, the non-conductive pad 82 may be formed from a ceramic, a dielectric, a non-conductive epoxy, any suitable type of insulative material, or a combination thereof.

The compression device 90 may be received within the passageway 92. The compression device 90 may be configured to apply a compressive force to the non-conductive pad 82 to compress the conductor 78 toward the first tubular member 36 to electrically couple the conductor 78 to the first conductor 50. In this way, the compression device 90 may be utilized to provide electrical connectivity across the threaded connection of the apparatus 32. In some embodiments, the electrical connection between the conductors 50 and 78 may be made after the tubular members 36 and 38 are coupled together to form the threaded connection of the apparatus 32 and are made-up by applying the desired torque.

In some embodiments, a patterning process may be used to apply the first non-conductive coating 46 and/or to form or apply the first conductor 50. For instance, the manufacturing process utilized to form the first conductor 50 or the first non-conductive coating 46 may include a variety of fabrication processes suitable for forming microscale or nanoscale structures. For example, in some embodiments, the manufacturing process may be a direct write process, an additive manufacturing process, or a combination thereof. Direct write and additive manufacturing processes may print, deposit, or otherwise form the first conductor 50 and/or the first non-conductive coating 46 in some embodiments. In at least some embodiments, the direct write or additive manufacturing processes may include forming the first non-conductive coating 46 or the first conductor 50 using a high precision, selective area deposition process. For example, in one embodiment, direct write technology available through MesoScribe Technologies of Stony Brook, N.Y. may be utilized. In the same or other embodiments, other direct write techniques that selectively deposit a desired material may be used, including but not limited to extrusion technologies that use positive pressure to extrude materials through a small nozzle onto the desired substrate, droplet-based technologies that eject small droplets of material onto the desired substrate, aerosol jetting technologies that aerosolize a material to create a gaseous stream that is aerodynamically focused and deposited on the desired substrate, laser-based technologies that use laser energy to transfer material onto the desired substrate, and tip-based deposition techniques that use capillary flow of an ink (or conductive or other material) on a tip onto the desired substrate. Still further, in other embodiments, any suitable additive manufacturing process that enables part fabrication via the layer-by-layer joining of material(s) may be utilized, including but not limited to laser or plasma sintering of powder onto the desired substrate, direct metal laser sintering, selective laser melting, selective laser sintering, fused deposition modeling, stereolithography, laminated object manufacturing, and electron beam melting. Additionally, in some embodiments, a suitable hybrid process may be used. Example hybrid processes may combine multiple direct write processes, multiple additive manufacturing processes, or any direct write processes with any additive manufacturing processes.

The first tubular member 36 may include a second conductor 52 (e.g., a conductive wire, plating, or film). In some embodiments, the second conductor 52 may be surrounded by a non-conductive material 54 in a bore 56 through the first tubular member 36. The second conductor 52 may be configured to be electrically coupled to the first conductor 50. As shown in the illustrated embodiment, the first tubular member 36 may further include a sealing assembly 53 (e.g., an 0-ring). In some embodiments, the sealing assembly 53 may provide a fluid seal between the first tubular member 36 and the second tubular member 38, provide pressure compensation during use, or be used for other reasons. In some embodiments, the position of the sealing assembly 53 may vary during operation to accommodate differences in pressure. While the sealing assembly 53 may be part of the first tubular member 36, in other embodiments, the sealing assembly 53 may be included in the second tubular member 38, or may be a standalone component that can be connected to the first tubular member 36 and/or the second tubular member 38.

According to one or more embodiments, a connection assembly 62 may be provided to electrically couple the first conductor 50 of the first tubular member 36 to a third conductor 64 (e.g., a conductive wire, plating, or film) of the second tubular member 38. In some embodiments, the third conductor 64 may extend through and/or along a body 70 of the second tubular member 38. In the embodiment illustrated in FIG. 1, the connection assembly 62 includes a body 66 and a non-conductive material 68. The body 66 may receive the third conductor 64 and the non-conductive material 68 (e.g., polytetrafluoroethylene) may surround the third conductor 64 in a first end 72 of the body 66. In some embodiments, a second end 74 of the body 66 may include a coupler 76 coupling the third conductor 64 to a fourth conductor 78 (e.g., a conductive wire, plating, or film). Optionally, the fourth conductor 78 is positioned in, or otherwise isolated by, a non-conductive material 80. The non-conductive material 80 may terminate in, or be coupled to, the non-conductive pad 82. The non-conductive material 80 may be a partial or complete electrical insulator configured to reduce or prevent the conduction of electricity. In some embodiments, the non-conductive material 80 may be a ceramic, a dielectric, a non-conductive epoxy, any suitable type of insulative material, or a combination thereof.

When the first tubular member 36 and the second tubular member 38 are coupled to form the threaded connection of the apparatus 32, the fourth conductor 78 may not be in electrical contact with the first conductor 50, and, thus, the third conductor 64 may not be electrically coupled to the first conductor 50. That is, the electrical connection between the first conductor 50 and the fourth conductor 78 may not be made at the same time the threaded connection of the apparatus 32 is made. The compression device 90 may, however, be used to selectively cause the fourth conductor 78 to contact the first conductor 50. In some embodiments, when the compression device 90 is selectively used in this manner, the compression device 90 may both establish electrical conductivity and seal the wiring cavity. For instance, once the first tubular member 36 and the second tubular member 38 are coupled (e.g., are threaded together), the fourth conductor 78 may be compressed onto the first conductor 50 via a compressive force generated by the compression device 90. In one embodiment, for instance, the compression device 90 may be inserted in a passageway 92 formed in the body 70 of the second tubular member 38 and used to exert a compressive force on the fourth conductor 78 that presses the fourth conductor 78 into contact with the first conductor 50.

In some embodiments, the compressive force on the fourth conductor 78 may be adjusted by adjusting the position of the compression device 90. For example, in one embodiment, the compression device 90 may be a screw (e.g., a set screw) that is configured to screw into the passageway 92. As the set screw is increasingly threaded into the body 70, the set screw or other compression device 90 may exert a force on the non-conductive pad 82. By virtue of the fourth conductor 78 being coupled to the non-conductive pad 82, the fourth conductor 78 may be forced into contact with the first conductor 50, and an electrical connection may be formed and maintained. The first conductor 50 and the third conductor 64 may then be electrically coupled via the fourth conductor 78. In this way, electrical conductivity may be provided across the threaded connection of the apparatus 32. In some embodiments, the wiring cavity may also be sealed in this manner.

It should be understood by a person having ordinary skill in the art having the benefit of the present disclosure that a variety of types of compression devices 90 may be utilized to apply the compressive force that electrically couples the fourth conductor 78 and the first conductor 50. Depending on the type of compression device 90 utilized in a given application, the passageway 92 or body 70 may be modified to ensure a tight and secure fit between the passageway 92 and the compression device 90. For example, the shape or dimensions of the passageway 92 may be chosen to accommodate the shape or dimensions of the compression device 90. In some embodiments, the dimensions may be chosen such that an interference fit or a threaded connection retains the compression device 90 in the passageway 92 during use. Indeed, any of a variety of suitable compression devices 90 (e.g., bolts, screws, clamps, pins, retention rings, etc.) and passageways 92 of various shapes (e.g., annular, square, rectangular, hexagonal, etc.) may be utilized.

FIG. 2 is a partial section view of portions of the apparatus of FIG. 1, according to one or more embodiments. In FIG. 2, a portion of the second tubular member 38 is not shown in order to illustrate some features of the first tubular member 36 in more detail. As shown in FIG. 2, in some embodiments, the second conductor 52 may be configured to be electrically coupled to the first conductor 50 formed or patterned on, or otherwise coupled to, a surface 58 of an end portion 48 of the first tubular member 36. Further, in certain embodiments, a covering 60 may be provided over the second conductor 52. The covering 60 may, in some embodiments, reduce or prevent the second conductor 52 from being exposed to the surrounding environment when the threaded connection of the apparatus 32 is not formed, or to other components of the apparatus 32 once the threaded connection of the apparatus 32 is formed.

Further, in certain embodiments, the first conductor 50 may be formed in a variety of sizes and shapes on the first tubular member 36 to enable the first conductor 50 and the fourth conductor 78 to be electrically coupled when the first tubular member 36 and the second tubular member 38 are in a variety of positions with respect to one another. For example, in some embodiments, a width 91 of the first conductor 50 may be varied to enable the fourth conductor 78 to be aligned with at least a portion of the first conductor 50 when the first tubular member 36 and the second tubular member 38 are tightly or loosely threaded together, have varying levels of wear at the shoulder portion of the connection, or are otherwise aligned in a variety of positions. The foregoing feature may enable alignment between the first conductor 50 and the fourth conductor 78 even when a shoulder 93 of the first tubular member 36 is not aligned with a corresponding shoulder of the second tubular member 38, or when the shoulder 93 or the corresponding shoulder of the second tubular member 38 wears down. In some embodiments, the width 91 may be between ¼ inch (0.6 cm) and 5 inches (12.7 cm). More particularly, the width 91 may be within a range that having lower and upper limits that include any of ¼ inch (0.6 cm) ½ inch (1.3 cm), ¾ inch (1.9 cm), 1 inch (2.5 cm), 1½ inch (3.8 cm), 2 inches (5.1 cm), 2.5 inches (6.4 cm), 3 inches (7.6 cm), 4 inches (10.2 cm), 5 inches (12.7 cm), or any values therebetween. For instance, the width 91 may be between ½ inch (1.3 cm) and 3 inches (7.6 cm), between 1 inch (2.5 cm) and 2 inches (5.1 cm), or between 1 inch (2.5 cm) and 4 inches (10.2 cm). In other embodiments, and as suitable for the given application, the width 91 may be less than ¼ inch (0.6 cm) or greater than 5 inches (12.7 cm).

Further, in certain embodiments, the first conductor 50 may be formed on the first tubular member 36 along the width 91 in a variety of suitable patterns. For instance, the first conductor 50 may have a solid pattern or, as shown in the embodiment illustrated in FIG. 2, the first conductor 50 may include a plurality of rows of conductive material 95 interspersed with non-conductive material 97. Where rows are provided, the rows of conductive material 95 may be arranged vertically, horizontally, or at an incline. Further, the width of each row, or spacing between rows, may be the same or may vary. In other embodiments, the conductive material 95 and the non-conductive material 97 may be formed in shapes other than rows, such as columns, circles, semicircles, squares, any other suitable pattern, or any combination of the foregoing. Further, in some embodiments, a ratio of the amount of conductive material 95 that is exposed relative to the amount of the non-conductive material 97 may be varied, depending on implementation-specific considerations. For example, the surface area of the first conductor 50 that is made up of the conductive material 95 may range between 25% and 100% in some embodiments. More particularly, the surface area of the first conductor 50 made up of the conductive material 95 may be within a range having lower and upper limits including any of 25%, 35%, 45%, 50%, 55%, 60%, 70%, 75%, 80%, 90%, 100%, and any values therebetween. In one embodiment, 50% of the surface area of the first conductor 50 may be made up of the conductive material 95. In other embodiments, the percentage of the surface area of the first conductor 50 made up of the conductive material 95 may be between 50% and 100%. In still other embodiments, less than 25% of the surface area of the first conductor 50 may be made up of the conductive material 95. In embodiments in which the surface area of the first conductor 50 is made up of less than 100% of the conductive material 95, the quantity and/or pattern of the conductive material 95 may be chosen such that a reliable connection may be established between the first conductor 50 and the fourth conductor 78 while reducing or minimizing the amount of the conductive material 95 deposited on, or otherwise coupled to, the first tubular member 36.

Still further, it should be noted that the placement and location of the conductors disclosed herein are not limited to those shown and may vary in other embodiments, depending on implementation-specific considerations. For example, in one embodiment, the first tubular member 36 and/or the second tubular member 38 (FIG. 1) may include a groove or recess formed along the respective inner diameters of such components and capable of accommodating one or more of the conductors. In other embodiments, however, one or more conductors may be positioned along an outer surface of the first and/or second tubular members 36, 38.

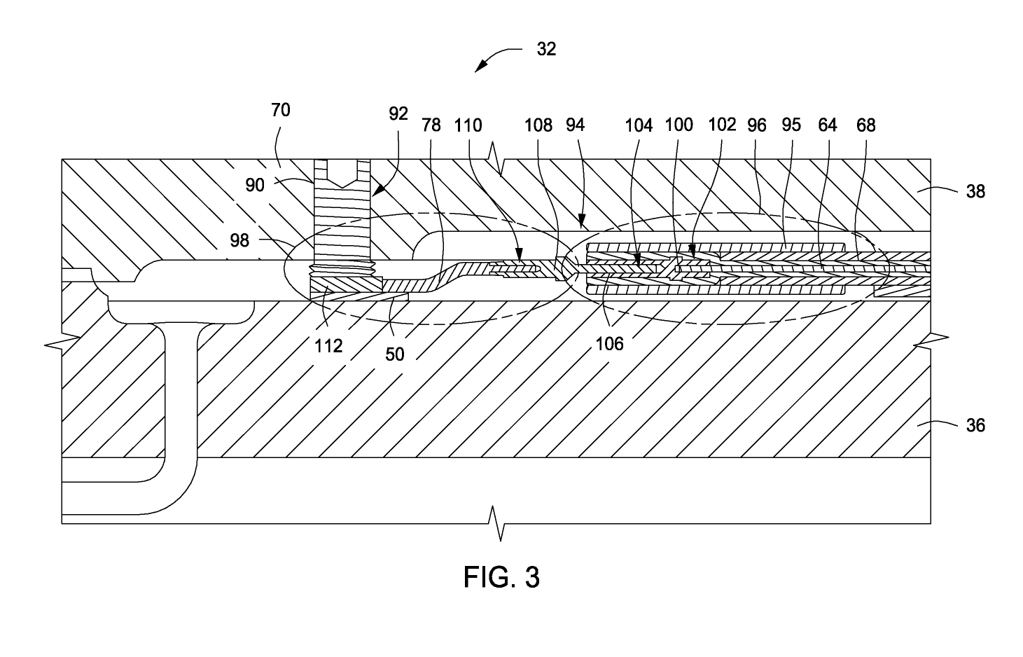

FIG. 3 is a partial section view of an illustrative connection assembly 94 that may be removable from the apparatus 32, according to one or more embodiments. The connection assembly 94 may be configured to electrically couple the first conductor 50 and the third conductor 64. In the embodiment of FIG. 3, a portion of the connection assembly 94 may be removable from the apparatus 32 and may be replaced if desired in a given application. More particularly, the illustrated connection assembly 94 may include a first connector 96 having a housing 95. The housing 95 and the first connector 96 may be configured to remain within the body 70 of the second tubular member 38 during and after use. A removable connector 98 may be configured to be removed or otherwise detached from the first connector 96 and the body 70. The first connector 96 may include an electrically conductive socket 100 defining a passageway 102 configured to receive or otherwise be coupled to the third conductor 64, and a passageway 104 configured to receive or otherwise be coupled to a pin portion 106 of a body 108 of the removable connector 98.

The removable connector 98 may include the body 108 having the pin portion 106 and a passageway 110 for receiving the fourth conductor 78. The fourth conductor 78 may extend to, and potentially terminate at, the removable pad 112. Prior to the threaded connection of the apparatus 32 being formed, the pin portion 106 of the removable connector 98 may be inserted into the passageway 104 of the first connector 96. The threaded connection of the apparatus 32 may then be made-up and the compression device 90 may inserted into the passageway 92 in the body 70 to urge the removable pad 112 and the fourth conductor 78 toward the first conductor 50. An electrical connection may thereby be established between the first conductor 50 and the fourth conductor 78, thereby also electrically coupling the first conductor 50 and the third conductor 64.

In some embodiments, the removable pad 112 may be disposable and replaced between uses or after a certain number of uses. For example, after repeated use, the removable pad 112 may wear from the compressive forces exerted by the compression device 90. In such embodiments, it may be desirable to remove the removable pad 112 from the removable connector 98 for replacement. As such, in some embodiments, the removable connector 98 may be configured to be removed from the first connector 96, and the removable pad 112 may be further configured to be removed from the removable connector 98.

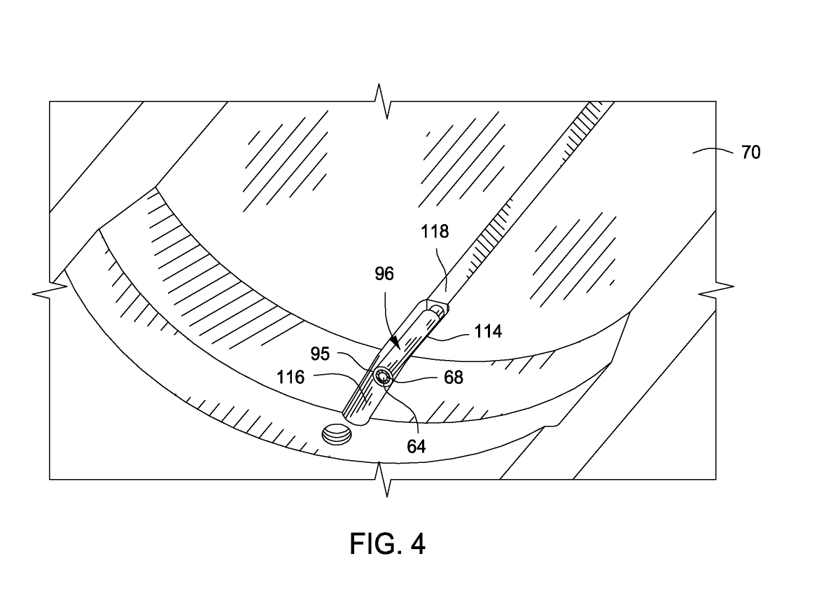

FIG. 4 is a partial section view of an illustrative threaded connection having a removable connector 98, according to one or more embodiments. In this embodiment, the first connector 96 is formed or located in a recess 116 in an inner surface 114 of the body 70. In this embodiment, the recess 116 may be formed in the inner surface 114 to accommodate the first connector 96. The recess 116 formed in the inner surface 114 may further enable clearance for components located within the body 70 or constrain movement of the first connector 96 within the confines of the recess 116. In some embodiments, a filler material 118 (e.g., solder, epoxy, etc.) may be provided and used to maintain the third conductor 64 in the desired location during operation.

Referring generally to FIGS. 3 and 4, during operation, when a connection is desired between the third conductor 64 and the first conductor 50 (FIG. 2), the removable connector 98 may be coupled to the first connector 96 in the recess 116 by inserting the pin portion 106 into the passageway 104. The compression device 90 may then be inserted into passageway 92 to force the removable pad 112 and the fourth conductor 78 toward the first conductor 50, thereby completing the electrical connection. The foregoing feature may enable an electrical connection to be formed across the threaded connection of the apparatus 32.

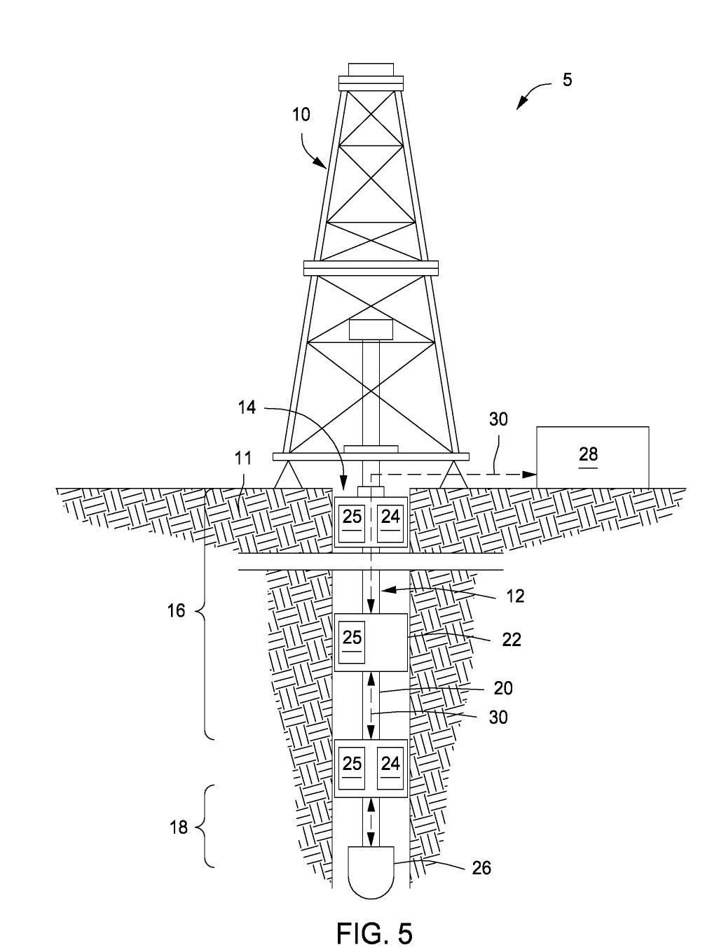

In some embodiments, the threaded connection of the apparatus 32 may be utilized as part of a system, such as a drilling system, to enable power and/or data transmission between system components. To that end, FIG. 5 is a schematic illustration of a drilling system 5, according to one or more embodiments. The drilling system 5 may include a downhole assembly 12 that extends in a wellbore 14 from a drilling rig 10. The downhole assembly 12 may include a drill string 16 and a bottomhole assembly (BHA) 18 attached to the distal or downhole end of the drill string 16. Although not depicted, the downhole system 12 may further include any number of motors, turbines, jars, measuring-while-drilling (MWD) modules, logging-while-drilling (LWD) modules, stabilizers, reamers, mills, and so forth.

The BHA 18 may include a bit 26, and may further include one or more LWD modules, MWD modules, downhole motors, drill collars, stabilizers, or the like. In some embodiments, the bit 26 may include a drill bit. In other embodiments, the bit 26 may include a lead mill, section mill, junk mill, casing mill, window mill, reamer, other cutting device or structure, or some combination of the foregoing.

The drill string 16 may include any suitable type of tubular components having a bore or passageway formed therethrough. In at least one embodiment, the drill string 16 may include two or more pipes 20 (e.g., drill pipes) joined together through one or more pipe joints 22. In some embodiments, the pipe joints 22 may include offset joints, angled joints, curved joints, or any other suitable joint, depending on implementation-specific considerations. In certain embodiments, the pipes 20 may have diameters measuring less than a foot, and the drill string 16 may extend more than a mile into the wellbore 14. In other embodiments, the pipes 20 may be larger, or the drill string 16 may extend a lesser length into the wellbore 14.

In at least some embodiments, the drill string 16 may further include or may be coupled to one or more sensor assemblies 24. The sensor assemblies 24 may include sensors, communication equipment, data-processing equipment, memory, other electronics or any combination of the foregoing for allowing operation of the sensor assemblies, the bit 26, the BHA 18, or some combination of the foregoing. Each pipe joint 22 may also include one or more communication devices 25 that allow electrical connectivity between adjacent pipes 20. The electrical connectivity may allow for power transfer along the pipes 20 or for controlling and/or communicating with other system components located in the wellbore 14 (e.g., via a control system 28). In some embodiments, the communication devices 25 may include any electrical conductor, compression device, or other tools to facilitate communication. Additionally, in certain embodiments, data may be communicated across one or more of the pipe joints 22 that do not include one of the sensor assemblies 24.

During operation, drilling fluid may be provided to the BHA 18 through a bore extending through the drill string 16. The drill string 16 may be rotated at the surface, thereby causing the BHA 18 to rotate within the wellbore 14. For example, a rotational inertia and axial force, or “weight-on-bit” (WOB), may be applied to the bit 26 to enable the bit 26 to drill through the formation, mill through casing or a downhole tool, or perform another downhole operation. In some embodiments, a turbodrill may utilize mechanical and hydraulic energy to deliver power to the bit 26 to enable the bit to drill through the subterranean formation 11. Further, in certain embodiments, a mud motor may be placed in the drill string 16 to provide power to the bit 26 by operating as a positive displacement motor.

Regardless of the type of drilling or other downhole system within the wellbore 14, the control system 28 may be used to collect and analyze the output data from the sensor assemblies 24. For example, the control system 28 may receive output data via the communication and power transmission pathway indicated by line 30. The control system 28 may process the output data and provide information that is a function of the processed or unprocessed output data from the sensor assemblies 24. For example, the control system 28 may provide an operator with the unprocessed measurements from several locations within the wellbore 14 or with processed data that shows, for instance, differences between the measurements taken at several locations within the wellbore 14. The control system 28 may be located within the wellbore 14 along with the downhole assembly 12, at the surface of the wellbore or some other location remote from the downhole assembly 12, or may be distributed among multiple locations (e.g., partially within the wellbore 14 and partially external to the wellbore 14). The control system 28 may include a terminal or interface with a terminal (not shown). The terminal may include a display device, input/output devices, or other components that give the operator the ability to interact with the control system 28. The control system 28 may also provide one or more automated processes to operate the drilling system 5. For instance, the control system 28 may receive output data from the sensor assemblies 24, optionally process the output data, and then use the processed or raw output data to control a downhole parameter of the downhole assembly 12. In some embodiments, the control of the downhole parameter may be automated, while in other embodiments an operator may interact with the control system 28 to control the downhole parameter.

Further, in certain embodiments, the control system 28, as well as any other controllers or processors disclosed herein, or data storage devices connected thereto, may include one or more computer-readable media. The term computer-readable media is intended to include two distinct types of media, namely computer storage media and transmission-type media. Combinations of computer storage media and transmission-type media are also intended to be encompassed by the term computer-readable media. Computer storage media includes tangible, machine-readable media, such as read-only memory (ROM), random access memory (RAM), solid state memory (e.g., flash memory), floppy diskettes, CD-ROMs, hard drives, universal serial bus (USB) drives, any other physical medium on which data is persistently or temporarily stored, or any combination thereof. Transmission-type media includes carrier waves, wireless signals, and communication links between processors or computer storage media. The computer storage media may store, and the transmission-type media may transmit or carry, encoded instructions, such as firmware or software, that may be executed by the control system 28 to operate the logic or portions of the logic presented in the methods disclosed herein. For example, in certain embodiments, the control system 28 may include computer-executable instructions (e.g., source code, machine code, binary code, etc.) stored on computer storage media or a process controller that includes computer storage media. The computer-executable instructions may include instructions for initiating a control function to change the position or other state (e.g., rotational speed, direction, etc.) of the downhole assembly 12 in response to feedback received from one or more of the sensor assemblies 24.

A variety of suitable parameters may be measured or calculated by the control system 28 utilizing feedback received from the sensor assemblies 24. To that end, the sensor assemblies 24 may include one or more sensors or other devices capable of collecting and/or providing information or data about one or more downhole parameters. Downhole parameters may include parameters related to the drilling system 5, the wellbore 14, the downhole assembly 12, or any combination of the foregoing. For example, the downhole parameters may include pressure, temperature, force, strain, stress, axial tension, WOB, torque, modulus of elasticity, rotational magnetic phase relative to a gravitational field, rotational position, acceleration, direction, inclination, collar revolutions per minute (rpm), velocity, temperature, vibration, any other desired parameter of the drilling operation, or any combination of the foregoing. The sensors in the sensor assemblies 24 may be configured to produce an output responsive to the data collected. For example, the sensors may be configured to collect data associated with the downhole parameters from the downhole assembly 12 and subsequently convert the collected data into an electrical, photonic, mud pulse, or other output through one or more processes. In one embodiment, the data collected and the output produced by the sensors may represent data and output over an interval of time. Thus, the data and output may be a frequency or frequency profile.

In some embodiments, the output from the sensor assemblies 24 may be unprocessed or obtained directly from the data collected by the sensor assemblies 24. In other embodiments, the output may be subjected to one or more processes. For example, the output may be subjected to algorithmic functions, high and/or low-pass frequency filters, time-integration, corrections, and so forth. The data collected or the output produced by the sensor assemblies 24 and transmitted to the control system 28 via the power transmission pathway at line 30 may be from a combination of sources. For example, one of the sensor assemblies 24 may be capable of collecting data to provide a value of a measured parameter at one location along the downhole assembly 12. Data from that one of the sensor assemblies 24 may be combined with the value of the measured parameter received from another sensor assembly 24 at a second location along the downhole assembly 12. Further, the sensor assemblies 24 may each be capable of measuring a different feature of the same parameter. For instance, the parameter may be acceleration, and the measured acceleration may include the acceleration from one or more modes of motion including, lateral acceleration, rotational acceleration, and axial acceleration.

In some embodiments, the positioning of the sensor assemblies 24 may be based on the particular data to be acquired for monitoring or optimizing the drilling system 5. For example, the sensor assemblies 24 may be located within or about the downhole assembly 12, drill collars, MWD or LWD modules, bit 26, other components of the drilling system 5, or any combination of the foregoing. The position of the sensor assemblies 24 with respect to the downhole assembly 12 may affect the data collected therefrom. For example, a sensor assembly 24 on an outer surface of the pipes 20 may provide a measured acceleration different from a sensor assembly 24 centered within the pipes 20.

In at least one embodiment, the sensor assemblies 24 may include one or more gyroscopes, magnetometers, accelerometers, strain gauges, semiconductor devices, photonic devices, quartz crystal devices, or the like. Gyroscopes may, for example, measure the rotational motion of the downhole assembly 12 or a component thereof. Magnetometers may, for example, measure a rotational or other magnetic phase relative to the Earth's gravitational field for the downhole assembly 12. In one embodiment, the rotational magnetic phase relative to the Earth's gravitational field can be used to identify a rotational position for the downhole assembly 12. The rotational position for the downhole assembly 12 may be used in a method of determining the rotational motion of the downhole assembly 12.

Further, in some embodiments, the sensor assemblies 24 may include temperature gauges or strain gauges coupled to an outer and/or inner surface of the downhole assembly 12. In one embodiment, the output from the strain gauges may be used to determine one or more parameters of the downhole assembly 12 including stress, torque, strain, bending moment, and so forth. For example, strain gauges may provide an output signal responsive to a modulus of elasticity of the downhole assembly 12. The modulus of elasticity or other output may then be used to calculate or otherwise identify the torque at the location of the strain gauges. In some embodiments, the sensor assemblies 24 may operate as controllers to receive data via the power transmission pathway shown by line 30. The sensor assemblies 24 may then further process the received data, or use the received raw data, to control a downhole component (e.g., motor, piston, etc.).

With reference to FIGS. 2 and 5, in some embodiments, the first tubular member 36 may be one of the pipes 20 of the downhole assembly 12, and the second tubular member may be another of the pipes 20 of the downhole assembly 12. The apparatus 32 may further be provided at one of the pipe joints 22. In such embodiments, the foregoing features of the apparatus 32 may enable the control system 28 to communicate across the pipe joints 22 to acquire data from the sensor assemblies 24 positioned at various locations along the length of the wellbore 14, to provide power to the sensor assemblies 24, to transmit data to the sensor assemblies 24, or to provide other data or power transmission or reception capabilities. For instance, such features may also enable the bidirectional transmission of power across the threaded connection of the apparatus 32, either in a downhole direction from a power module or in an uphole direction from a power generator located within the downhole assembly 12. One skilled in the art should appreciate in view of the disclosure herein, however, that presently disclosed embodiments are not so limited. Indeed, embodiments of the present disclosure may be practiced outside of oilfield or downhole applications and could be used in a variety of systems or applications in which electrical connectivity is desired across mechanical connections to enable data or power transfer across the mechanical connections.

Further, in some embodiments, the first tubular member 36 may be one portion of a turbodrill, and the second tubular member 38 may be another portion of the turbodrill. For example, the first and second tubular members 36 and 38 may be drill pipe (e.g., for standard drilling). In such an embodiment, the first tubular member 36 may be a pin end of the threaded connection of the apparatus 32, and the second tubular member 38 may be a box end of the threaded connection of the apparatus 32. In some embodiments, a single pipe 30 may include both a pin and a box end. In such an embodiment, the pipe 30 may include the first tubular member 36 at the pin end thereof, and the same pipe 30 may include the second tubular member 38 at the box end thereof. In such an embodiment, the first conductor 50 may be coupled to, or integral with, the third conductor 64 which may extend along a length of the pipe 30 and be coupled to, or integral with, the second conductor 52. In such embodiments, the pin end and the box end of one pipe 30 may each be threaded to a different pipe 30 to form a portion of a drill string. In the drill string, power and/or communication may be established along the full length of the drill string through the apparatus 32 at each end of the intermediate one of the pipes 30. In other embodiments, however, a single drill pipe 30 may include two pin ends or two box ends. Still further, in other embodiments, the first and second tubular members 36 and 38 may be housing, such as turbodrill power or bearing section housing.

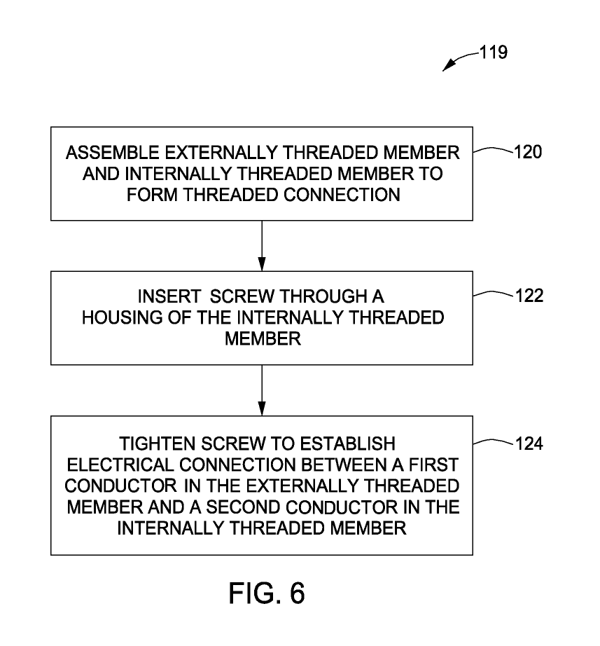

FIG. 6 is a flow chart illustrating a method 119 for providing electrical conductivity across a threaded connection, according to one or more disclosed embodiments. In the illustrated embodiment, the method 119 may include assembling an externally threaded member and an internally threaded member to form a threaded connection (block 120). In some embodiments, the threaded connection formed in block 120 may be a rotary shouldered connection. The method 119 may also include inserting a screw through a housing of the internally threaded member (block 122). In some embodiments, inserting the screw in block 122 may be performed after the threaded connection is fully or partially formed. In other embodiments, however, inserting the screw in block 122 may be performed before the threaded connection is formed in block 120. The screw that is inserted may be an external or internal screw. Insertion of the external screw in block 122 may be used, in some embodiments, to generate a compressive force. For instance, the compressive force may be generated to act on a wire, on plating, or on a conductive film within the threaded connection.

The method 119 may further include tightening the screw to establish an electrical connection between a first conductor in the externally threaded connection and a second conductor in the internally threaded connection (block 124). In at least some embodiments, tightening the screw may compress the first conductor and move it from a position that is radially outward or otherwise offset from the second conductor to a radially inward position in which the first conductor contacts the second conductor. According to one or more embodiments, the screw may be positioned within a threaded region of the threaded connection (i.e., in a region where the pin and box threads are located), although in other embodiments the screw may be poisoned outside the threaded region of the threaded connection.

By assembling the threaded connection in accordance with the disclosed embodiment of FIG. 6, an electrical connection may be formed across a mechanical connection. The foregoing feature may enable improved reliability of the electrical connection as compared to systems that establish the electrical connection during the assembly. Further, this feature may reduce the wiring complexity or use of custom-designed connectors, and may increase the likelihood that off-the-shelf parts may be used for some or all of the assembly. For example, in the embodiment of FIG. 4, the compression device 90 may be an off-the-shelf set screw, and the passageway 92 may be formed to accommodate the off-the-shelf or standard set screw. For a further example, the electrically conductive socket 100, the body 108, or other components may be off-the-shelf, standard, or readily available parts.

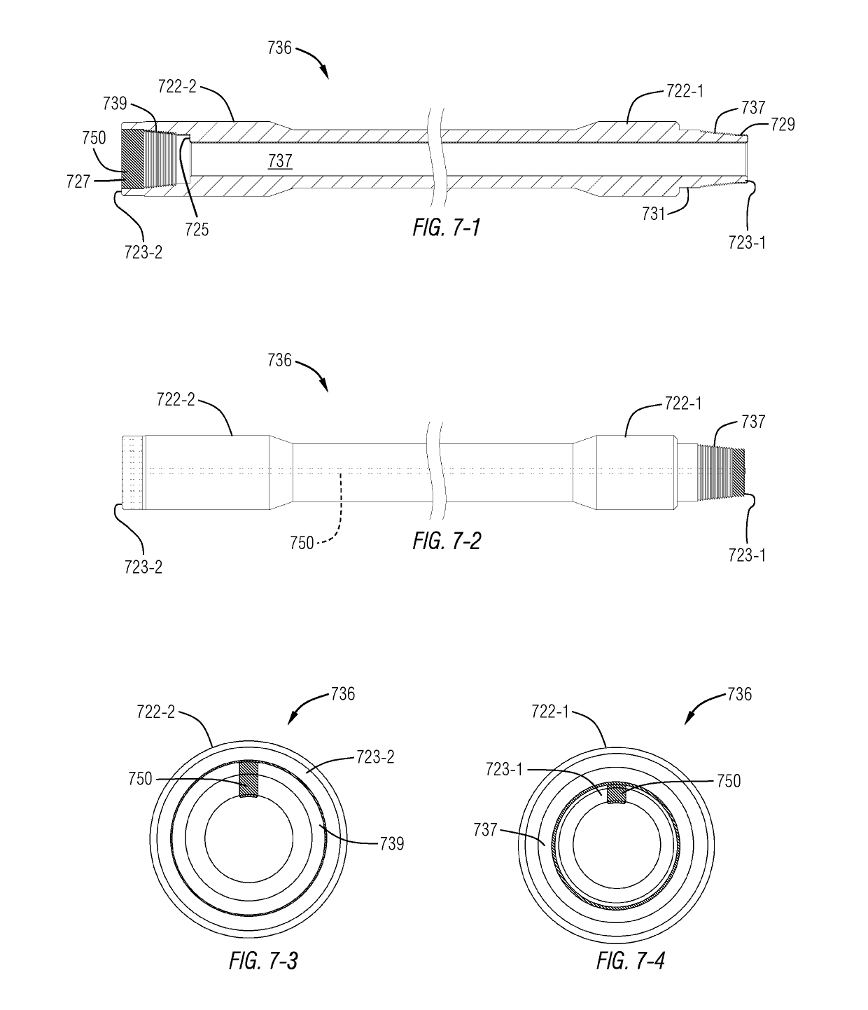

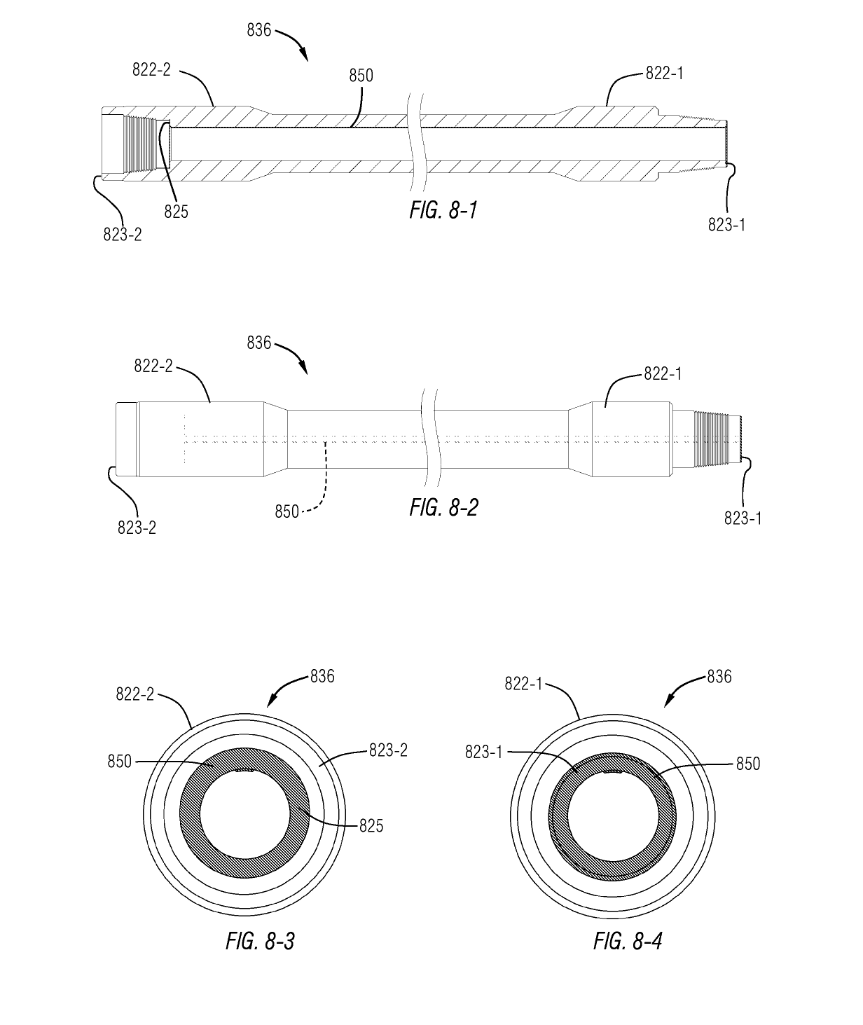

Turning now to FIGS. 7-1 to 8-4, various additional examples of tubular members for providing electrical conductivity across a tool joint, including over a threaded connection, are illustrated in some additional detail. In particular, FIGS. 7-1 to 7-4 illustrate a first embodiment of a tubular member 736 having two tool joints on opposing ends thereof, and a body extending therebetween. In particular, the illustrated embodiment of the tubular member 736 includes a pin joint 722-1 with corresponding external or pin threads 737 and a box joint 722-2 with corresponding internal or box threads 739. The pin and box joints 722-1, 722-2 may be configured to mate with corresponding tubular members having similar tool joints. In some embodiments, the tubular member 736 (or a mating tubular member) may be a drill pipe, transition or heavy weight drill pipe, or drill collar. The tubular member 736 may be another downhole tool in other embodiments, including potentially a turbodrill, downhole motor, reamer, bridge plug, MWD, LWD, bypass valve, jar, vibration tool, or other downhole tool. In some embodiments, the tool joints 722-1, 722-2 may be configured to mate with corresponding connections using a so-called double shoulder connection.

As discussed herein, when establishing electrical conductivity between mating tubular members (such as tubular member 736), bi-directional data and/or power transmission may be established across the threaded connection or tool joint. In some embodiments, the electrical conductivity may be established by making up the connection to cause a conductor 750 to couple with a mating component. The conductor 750 may include any conductive material, and in some embodiments the conductive material may be deposited, nano-layered, coated, or otherwise applied to the tubular member 736. In the particular embodiment shown in FIGS. 7-1 to 7-4, the conductor may include a material, which is applied to an internal surface defining a bore 737 in the tubular member 736. The conductor 750 may extend fully or partially between opposing end faces 723-1, 723-2 of the tubular member. According to at least some embodiment, drilling fluid may flow within the bore 737, which may wear away the conductor 750. In at least some embodiments, the conductor 750 may be easily applied so as to be applied at the rig-site or at an inspection facility, to repair or even replace worn away conductors 750.

More specifically, in FIGS. 7-1 to 7-4, the conductor 750 may be applied as a thin layer (or multiple thin layers) along an internal surface of the tubular member 736. The thin layer(s) may extend along an internal shoulder 725 of the box joint 722-2, internal threads 736, and along an internal surface 727 adjacent the box end face 723-2. In some embodiments, the conductor 750 may extend around a full or partial circumference of the internal surface 727. In a similar manner, the conductor 750 may extend along the internal surface and onto the pin end face 723-1, and even potentially onto an external surface 729. In some embodiments, the conductor 750 may extend onto the threads 737 and/or one or more additional external surfaces 731. The conductor 750 may be a thin strip on such surface or components. In the same or other embodiments, the conductor 750 may extend around a full or partial portion of one or more of such surfaces (e.g., external surface 729 and/or external surface 731. In some embodiments, when a pin joint of a mating tubular member mates with the box joint 722-2 of the tubular member 732, a corresponding conductor on the pin joint may contact a portion of the conductor 750 in the bod joint 722-2 to establish an electrical connection. By extending the conductor 750 around a larger surface area of a portion of the box joint 722-2 (and/or corresponding pin joint of a mating tubular member), mating engagement can ensure conductors 750 mate, even if the strips of conductive material do not line up. As discussed herein, patterns of conductive material may be applied to ensure a connection.

Any number of suitable materials may be used, and combinations of conductive and non-conductive (or lower conductivity) materials may be used in some embodiments. For instance, using a direct write, additive manufacturing, or other technique, a conductive layer including copper, aluminum, silver, graphene, gold, iron-chrome-aluminum, molybdenum disilicide, or other low resistivity materials may be deposited directly on a surface of the tubular member 736. Optionally, one or more other conductive layers of the same or different materials may be added to increase a thickness of the layer. One or more coating or non-conductive, or lower conductivity, layers may also be added. For instance, a lower conductivity tungsten carbide, nickel, steel, lead, or titanium, graphite, silicon, polymer (e.g., polytetrafluoroethylene), other materials, or combinations of the foregoing, may be applied as a layer or coating to a full or partial portion of the conductor 750 along the internal surface 727. In contrast, portions of the conductor 750 along one or more of the internal shoulder 725, pox joint 722-2, internal threads 736, or internal surface 727, where contact with a mating component occurs, may not include the non-conducitve/lower conductivity layer or coating, or may include a decreased thickness or different type of coating (e.g., a non-conductive coating that will crack or break away upon contact to expose a conductive layer). In some embodiments, one or more non-conductive layers may be applied below a conductive layer, and may act as a substrate to isolate the conductor from the body of the tubular member 736. Thus, the conductor 750 may include both conductive and non-conductive materials or layers in some embodiments.

FIGS. 8-1 to 8-4 illustrate a similar tubular member 836 according to some embodiments of the present disclosure. The tubular member 836 may also include a conductor 850; however, less conductive material may be used for the conductor 850 as compared to the conductor 750 of FIGS. 7-1 to 7-4. For instance, the conductor 850 is shown as extending as a thin strip (see FIGS. 8-2 to 8-4) along the internal surface of the tubular member 836. The conductor 850 may then extend an internal shoulder 825. In some embodiments, the conductor may be applied to a full or significant area of the internal shoulder 825. The conductor 850 may also extend onto the pin end face 823-1 of the pin joint 822-1. In some embodiments, the conductor may be applied to a full or significant area of the pin end face 823-1. When a threaded connection is made-up using the tubular member 836, a similar pin joint 822-1 may be threaded into the box joint 822-2. The joints may shoulder out, such that the pin end face (e.g., 823-1) contacts the internal shoulder 825. As a result, the conductors 850 may contact to allow electrical communication.

As discussed with respect to FIGS. 7-1 to 7-4, the conductor 850 may include any number of layers and materials, and such layers/materials may be consistent along a full length of the conductor 850, or may vary from location-to-location (e.g., a portion of a conductor 850 at a point of contact with a conductor of a mating tubular member may be different than a portion of a conductor 850 that will not have such contact and which may be exposed to fluid flow.

As used herein, the term “conductive” and “conductive materials” is used to refer to materials having an electrical conductivity less than 5.0.10⁻⁸ ρ(Ω·m) at 20° C. For instance, copper has an electrical conductivity of about 1.540⁻⁸ ρ(Ω·m), and aluminum has an electrical conductivity of about 2.540⁻⁸ ρ(Ω·m). Highly conductive materials may be considered to be those conductive materials having an electrical conductivity less than 3.0.10⁻⁸ ρ(Ω·m). As used herein, “non-conductive” or “non-conductive materials” includes lower conductivity materials and any other materials having an electrical conductivity greater than about 5.0.10⁻⁸ ρ(Ω·m). For instance, lower conductivity materials within the non-conductive material category includes those having an electrical conductivity less than 1.0.10⁻⁶ ρ(Ω·m). Examples of lower conductivity materials include tungsten (electrical conductivity is about 5.5.10⁻⁸ ρ(Ω·m)), nickel (electrical conductivity is about 7.0.10⁻⁸ ρ(Ω·m)), iron (electrical conductivity is about 1.0.10⁻⁷ ρ(Ω·m)), lead (electrical conductivity is about 2.0.10⁻⁷ ρ(Ω·m)), and stainless steel (7.0.10⁻⁷ ρ(Ω·m)). Other non-conductive materials that are not within the category of lower conductive materials may include graphite (electrical conductivity is about 3.0.10⁻⁶ ρ(Ω·m), silicon (electrical conductivity is about 6.5.10² ρ(Ω·m)), rubber (electrical conductivity is about 1.10¹³ ρ(Ω·m)), and polytetrafluoroethylene (electrical conductivity is about 1.0.10²⁴ ρ(Ω·m)).

FIGS. 9-13 are provided merely by way of illustration, and schematically illustrate some example configurations of conductors at one or more portions of a tubular member or other component. FIG. 9, for instance, illustrates a single material 952 forming the conductor 950. The full thickness (measured down-to-up in the orientation shown in FIG. 9), and width (measured left-to-right in the orientation shown in FIG. 9), may be formed of the same conductive material 952. The illustrated cross-section may be consistent along a full length of the conductor along a tubular member (see FIGS. 7-2 and 8-2), or different portions of the conductor may have different configurations along the length thereof.

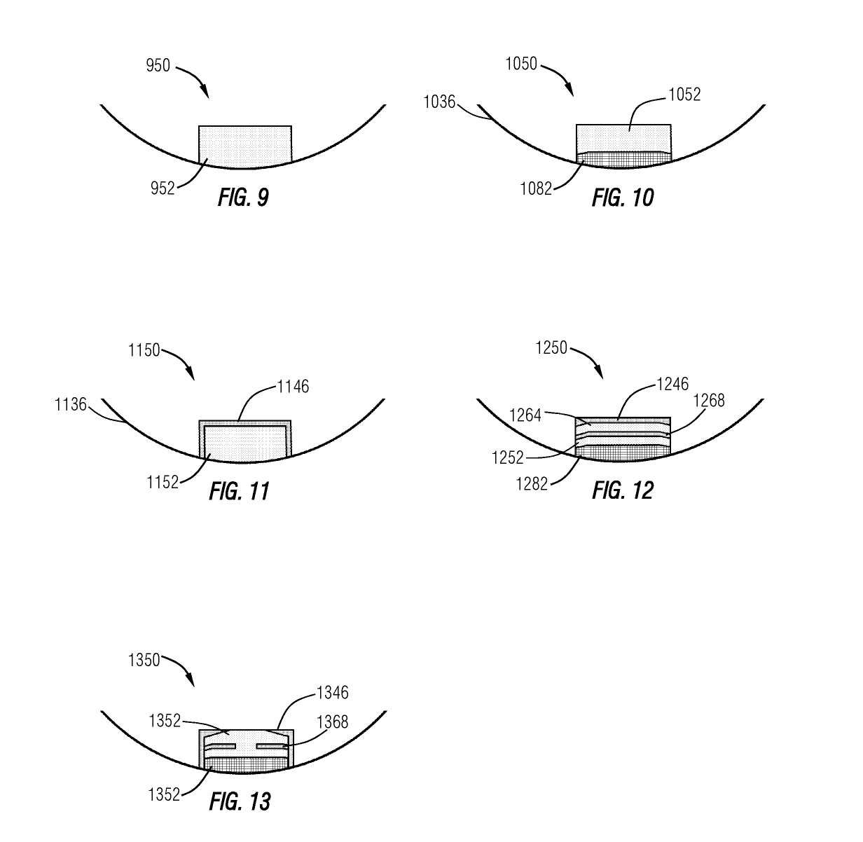

FIG. 10 illustrates still another example conductor 1050 according to some embodiments of the present disclosure. The conductor 1050 may be deposited or otherwise formed with a non-conductive pad or substrate 1082 along a contact surface on an interior of a tubular member 1036. A conductive material 1052 may then be deposited or formed on an upper (or interior) surface of the non-conductive substrate 1082. The configuration shown in FIG. 10 may be used to isolate the conductive material relative to the tubular member 1036.

The particular configuration of the conductor 1050 of FIG. 10 is merely illustrative. For instance, while FIG. 10 illustrates the non-conductive substrate 1082 and conductive material 1052 as having the same width, in other embodiments, the conductive material 1052 may have a lesser width, or the conductive material 1052 may have a greater width and may extend over one or more sides of the non-conductive substrate, and potentially even extend into contact with the tubular member 1036. Additionally, while the conductive material 1052 is shown as having a greater thickness (or more layers) than the non-conductive substrate 1082, in other embodiments, the conductive and non-conductive materials 1052, 1082 may have about the same thickness, or the non-conductive substrate 1082 may have a greater thickness. According to at least some embodiments, the conductor 1050 has the same configuration across a full length of a tubular member or other component; however, in other embodiments the configuration shown in FIG. 10 is used along a partial length of the conductor 1050. For instance, the configuration in FIG. 10 may be used along a portion of a tubular member that is made of a conductive material, and may transition to a configuration such as that shown in FIG. 9 along a portion of the tubular member made of a non-conductive material.

Another example of a conductor 1150 is shown in FIG. 11. In this particular example, the conductor 1150 may be formed by depositing or otherwise forming one or more layers of a conductive material 1152 on an inner surface of a tubular member 1136. Thereafter, one or more layers of a different material may be formed on or around the conductive material 1152. The one or more additional layers may include a non-conductive coating or material 1146; however, in other embodiments, the one or more additional layers may include other conductive materials. In FIG. 11, the non-conductive material 1146 is shown as covering both the top (or interior) surface, and both side surfaces of the conductive material 1152. In this way, the conductive material 1152 may be encapsulated by the non-conductive material 1146. This may be used, for instance, to protect the conductive material 1152 against wear and erosion (e.g., as drilling fluid flows through the tubular member 1136). In other embodiments, however, the top/inner surface of the conductive material 1152 may be uncovered, and a single side or both sides may include the non-conductive material 1146 fully or partially therealong. In still other embodiments, the top/inner surface of the conductive material 1152 may be fully or partially covered by the non-conductive material 1146, and one or both side surfaces may be uncovered.

The non-conductive material 1146 may act as protective coating in some embodiments. In at least some embodiments, the non-conductive material 1146 may have a thickness that is between 5% and 50% of the thickness of the conductive material 1152. In other embodiments, however, the thickness may be less than 5% or greater than 50%. Further, while the conductive material 1152 may have a greater thickness (or more layers) than the non-conductive material 1146, in other embodiments, the conductive and non-conductive materials 1152, 1146 may have about the same thickness, or the non-conductive material 1146 may have a greater thickness. Additionally, according to at least some embodiments, the conductor 1150 has the same configuration across a full length of a tubular member or other component; however, in other embodiments the configuration shown in FIG. 11 is used along a partial length of the conductor 1150. For instance, the configuration in FIG. 11 may be used along a portion of a tubular member that does not directly engage a conductor of a mating component, and may transition to an uncoated configuration such as that shown in FIG. 9, or some other configuration including an exposed conductive material (see FIG. 13) along a portion of the tubular member that does directly engage a corresponding component.

Any number of different layers or configurations of materials may be used for a conductor, as shown in FIGS. 12 and 13. In FIG. 12, for instance, the conductor 1250 may include a bottom (or outer) surface that includes a non-conductive pad or substrate 1282. Moving toward the top (or inner) surface of the conductor 1250, may be a conductive material 1252, a non-conductive material 1268, a conductive material 1262, and a nonOconductive material 1246. The conductive materials 1252, 1264 may be the same material, or may be different materials. Further, in some embodiments, the non-conductive materials 1246, 1268 may be the same material, or may be different materials. Optionally, one or more of the non-conductive materials 1246, 1268 may include a same or different material as the non-conductive substrate 1282. Further, while a non-conductive material is shown as being included between two layers of conductive materials 1252, 1264, in other embodiments, two layers of conductive materials may be directly adjacent each other (e.g., by removing non-conductive material 1268). As discussed herein, the conductor 1250 in FIG. 12 is merely illustrative. Thus, while each layer is shown as having exposed side surfaces, in other embodiments the non-conductive material 1246 (or another material) may form a layer that encloses the side surfaces. Such enclosure may be used to physically isolate or protect internal layers of the conductor 1250, to electrically isolate layers, or for other purposes. Additionally, the conductor 1250 as configured in FIG. 12 may extend a full or partial length of a tubular member or other component, as discussed herein.

FIG. 13 includes a conductor 1350 that is similar to the conductor 1250 of FIG. 12, except that the side surfaces of the conductor 1350 are enclosed by an upper non-conductive material 1346 that does not fully extend across the full top (internal) surface of the conductor 1350, and the internal non-conductive material 1368 extends a partial width of the conductor 1350. As a result, a conductive material 1352 may be positioned on both upper and lower sides of the non-conductive layer 1368. In other embodiments, different conductive or non-conductive materials may be positioned on the different upper and lower sides of the partial layer of the non-conductive material 1368. Ad discussed herein, the conductor 1350 is merely illustrative, and may be varied in any number of manners. Further, the conductor 1350 as configured in FIG. 13 may extend a full or partial length of a tubular member or other component. For instance, the conductor 1350 may be positioned at an interface of a tubular member that engages a corresponding interface of a mating tubular member. The exposed conductive material 1352 at the top/inner surface may contact a conductive material of the mating tubular member. The same configuration may extend a full length of the tubular member, or the conductor 1350 may transition to a different configuration (e.g., a configuration with a protected conductive layer (e.g., conductor 1150 or 1250 of FIGS. 11 and 12).

FIGS. 9-13 illustrate example conductors that extend partially along an interior circumference of a corresponding tubular member; however, such conductors are not limited to such configurations. For instance, the conductors may extend along lesser or greater portions of an interior circumference, or even along a full interior circumference of a tubular member. In other embodiments, the conductors may be positioned on an outer circumference or portion of a tubular member. Further, while the illustrations may be used to obtain example comparisons of material or layer thicknesses of a conductor (and can thus be considered to be to scale relative to other material layers), the present disclosure is not so limited as materials may have any number of different thicknesses. In some embodiments, the material thickness is controlled by the number of layers of each material deposited, although thickness may be controlled in other manners. In embodiments where the number of layers is used to control material thickness, each material may have the same or a different individual layer thickness. For instance, to build-up a conductive material having a thickness of 2 mm, 400 layers of the conductive material may be deposited (i.e., each layer of the conductive material may have a thickness of about 5 μm). To build-up a non-conductive material (or a different conductive material) having a thickness of 2 mm, 400 layers of the other material may be deposited, with each having a thickness of about 5 μm. In other cases, however, fewer than 400 layers may be deposited (e.g., 200 layers each having a thickness of about 10 μm), or more than 400 layers may be deposited (e.g., 2000 layers each having a thickness of about 1 μm).

In the description herein, various relational terms are provided to facilitate an understanding of various aspects of some embodiments of the present disclosure. Relational terms such as “bottom,” “below,” “top,” “above,” “back,” “front,” “left,” “right,” “rear,” “forward,” “up,” “down,” “horizontal,” “vertical,” “clockwise,” “counterclockwise,” “upper,” “lower,” “uphole,” “downhole,” and the like, may be used to describe various components, including their operation and/or illustrated position relative to one or more other components. Relational terms do not indicate a particular orientation for each embodiment within the scope of the description or claims. For example, a component of a threaded connection that is described as “downhole” relative to another component may be further from the surface while within a vertical wellbore, but may have a different orientation during assembly, when removed from the wellbore, or in a deviated borehole. Accordingly, relational descriptions are intended solely for convenience in facilitating reference to various components, but such relational aspects may be reversed, flipped, rotated, moved in space, placed in a diagonal orientation or position, placed horizontally or vertically, or similarly modified. Certain descriptions or designations of components as “first,” “second,” “third,” and the like may also be used to differentiate between similar components or components that may be capable of being described in similar terms. Such language is not intended to limit a component to a singular designation. As such, a component referenced in the specification as the “first” component may be the same or different than a component that is referenced in the claims as a “first” component.

Furthermore, while the description or claims may refer to “an additional” or “other” element, feature, aspect, component, or the like, it does not preclude there being a single element, or more than one, of the additional element. Where the claims or description refer to “a” or “an” element, such reference is not be construed that there is just one of that element, but is instead to be inclusive of other components and understood as “at least one” of the element. It is to be understood that where the specification states that a component, feature, structure, function, or characteristic “may,” “might,” “can,” or “could” be included, that particular component, feature, structure, or characteristic is provided or included in some embodiments, but is optional for other embodiments of the present disclosure. The terms “couple,” “coupled,” “connect,” “connection,” “connected,” “in connection with,” and “connecting” refer to “in direct connection with,” or “in connection with via one or more intermediate elements or members.” Components that are “integral” or “integrally” formed include components made from the same piece of material, or sets of materials, such as by being commonly molded or cast from the same material, or commonly machined from the same piece of material stock. Components that are “integral” should also be understood to be “coupled” together.

Although various example embodiments have been described in detail herein, those skilled in the art will readily appreciate in view of the present disclosure that many modifications are possible in the example embodiments without materially departing from the present disclosure. Accordingly, any such modifications are intended to be included within the scope of this disclosure. Likewise, while the disclosure herein contains certain specifics, these specifics should not be construed as limiting the scope of the disclosure or any of the appended claims, but merely as providing information pertinent to one or more specific embodiments that may fall within the scope of the disclosure and the appended claims. It is contemplated that any described features from the various embodiments disclosed may be used in combination.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

While embodiments disclosed herein may be used in an oil, gas, or other hydrocarbon exploration or production environment, such environment is merely illustrative. Systems, tools, assemblies, threaded connections, electrical couplings, methods, and other components of the present disclosure, or which would be appreciated in view of the disclosure herein, may be used in other applications and environments. In other embodiments, threaded connections, electrical couplings, or other aspects of embodiments discussed herein, or which would be appreciated in view of the disclosure herein, may be used outside of a hydrocarbon production environment, including in connection with other systems, including within automotive, aquatic, aerospace, hydroelectric, manufacturing, other industries, or even in other downhole environments. The terms “well,” “wellbore,” “borehole,” and the like are therefore also not intended to limit embodiments of the present disclosure to a particular industry. A wellbore or borehole may, for instance, be used for oil and gas production and exploration, water production and exploration, mining, utility line placement, or myriad other applications.

Certain embodiments and features may have been described using percentages, ratios, quantities, or other numerical values. It should be appreciated that ranges including the combination of any two values are contemplated unless otherwise indicated, and that a particular value may be defined by a range having the same lower and upper limit. All numbers, percentages, ratios, measurements, or other values stated herein are intended to include the stated value as well as other values that are about or approximately the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least experimental error and variations that would be expected by a person having ordinary skill in the art, as well as the variation to be expected in a suitable manufacturing or production process. A value that is about or approximately the stated value and is therefore encompassed by the stated value may further include values that are at least within 5%, within 1%, within 0.1%, or within 0.01% of a stated value.

The abstract at the end of this disclosure is provided to allow the reader to quickly ascertain the general nature of some embodiments of the present disclosure. It is submitted with the understanding that it will not be used to interpret or limit the scope or meaning of the claims.

What is claimed is:

1. A tubular member, comprising:
a body;
tool joints on opposing ends of the body; and
a conductor extending along a full length of the body and along at least a portion of each of the tool joints, the conductor including a strip of conductive material deposited on an interior surface of the body and the tool joints.

2. The tubular member of claim 1, the conductor extending between at least an internal shoulder of a box joint of the tool joints and an end face of a pin joint of the tool joints.

3. The tubular member of claim 2, the conductor extending circumferentially around at least one of the internal shoulder of the box joint or the end face of the pin joint.

4. The tubular member of claim 3, the conductor extending circumferentially by covering at least a substantial portion of a full circumference of at least one of the internal shoulder of the box joint or the end face of the pin joint.

5. The tubular member of claim 2, the conductor extending between at least an end face of the pin joint and an internal surface adjacent an end face of the box joint.

6. The tubular member of claim 5, the conductor extending circumferentially around at least one of the internal surface or the end face of the pin joint.

7. The tubular member of claim 5, the conductor extending circumferentially by covering at least a substantial portion of a full circumference of at least one of the internal surface of the box joint or the end face of the pin joint.

8. A method for providing electrical conductivity across a tool joint, comprising:
threadably coupling a pin joint of a first tubular member to a box joint of a second tubular member, the first tubular member including a first conductive material on an end face of the pin joint, and the second tubular member including a second conductive material on an internal shoulder of the box joint; and
shouldering out the pin joint and the box joint, thereby causing the first conductive material to contact the second material.

9. The method of claim 8, the first and second conductive materials being the same.

10. The method of claim 8, the first conductive material extending substantially a full length of the first tubular member.

11. The method of claim 8, the second conductive material extending substantially a full length of the second tubular member.

12. The method of claim 8, the first conductive material extending circumferentially around the end face of the pin joint.

13. The method of claim 8, the second conductive material extending circumferentially around the end face of the pin joint.

14. The method of claim 8, the first conductive material being positioned substantially as a strip along the first tubular member.

15. The method of claim 8, the second conductive material being positioned substantially as a strip along the second tubular member.

16. The method of claim 8, the first and second tubular members being drill pipe.

17. The method of claim 8, further comprising:
flowing drilling fluid through the first and second tubular members.

18. The method of claim 17, wherein flowing drilling fluid damages at least one of the first or second conductive material, the method further comprising:
repairing or replacing at least one of the first or second conductive materials at a rig or inspection site.

19. The method of claim 18, wherein repairing or replacing includes using a direct write process to deposit the at least one of the first or second conductive materials.

20. The method of claim 18, wherein using the direct write process includes directly writing multiple layers of conductive materials, and wherein using the direct write process further includes directly writing at least one layer of a lower conductivity material on or within layers of the conductive materials.
